(19) United States
(12) Patent Application Publication
(10) Pub. No.: US 2006/0105137 A1
(43) Pub. Date: May 18, 2006

(54) Combination carry bag

(76) Inventor: Caroline Kouts, Victoria (AU)

Correspondence Address: EDWIN D. SCHINDLER, FIVE HIRSCH AVENUE, P.O. BOX 966, CORAM, NY, 11727-0966, US

(21) Appl. No.: 10/531,096

(22) PCT Filed: Jun. 18, 2004
(86) PCT No.: PCT/AU04/00803

§ 371 Date: Dec. 23, 2005

(30) Foreign Application Priority Data
Jul. 2, 2003 (AU) 2003903405

(51) Int. Cl. B32B 3/06

(52) U.S. Cl. 428/99

(57) ABSTRACT

A mat has a first surface and a second surface which, in an open orientation, includes a substantially elongate portion which is adapted to engage a removable fabric mat on the first surface. The mat further includes side storage portions having pockets for item storage which, in the open orientation, extend laterally from, and at least partially along, the length of the sides of the substantially elongate portion. The mat, which may include a handle, is able to be folded and fastened in a closed orientation into a portable bag.

### BACKGROUND TO THE INVENTION

This invention relates to accessories required for use by parents or carers of babies and in particular to the large array of products and equipment which need to be carried with a baby whenever the baby travels away from home.

Whenever a baby is away from its home it is necessary for the baby's carer, who for convenience sake here will be referred to as the parent, to carry bags full of nappies and associated products in order to change nappies as required. In addition some blanket or other such device is usually carried to place on a floor or table for the baby to lie upon while being changed.

Of course in the home baby change tables can be provided where all the equipment required is easily accessible.

The problem then with going out with a baby is that a large quantity of items need to be packed in a bag or bags, resulting in a cumbersome load which may not only be difficult to carry but the parent may have difficulty accessing items as required with any degree of ease. In addition it is common for a large item such as a mat or blanket to be carried onto which a baby can be placed while nappy changing takes place. A further problem is remembering to pack all the items which may be needed.

### SUMMARY OF THE INVENTION

It is an object of this invention to provide a simple means of carrying items of baby maintenance equipment such that the items are readily accessible whenever required. It is a further object of the invention to provide a substitute portable baby change table which can be easily carried and used as part of the item carrying means.

The invention is a mat device having a first and second surface which, in an open orientation, includes a generally elongate portion which is adapted to engage with a removable fabric mat on the first surface, the mat device further includes side storage portions having pocket devices for item storage which, in this open orientation, extend laterally from and at least partially along the length of the lengthwise sides of the elongate portion, the arrangement being such that the mat device can be folded and fastened in a closed orientation into a portable bag, the device being provided with handle means.

It is preferred that the storage portions be folded over one and other across the first surface while opposing ends of the elongate portion fold over these components and engage with fastening means provided on the second surface to form a portable bag.

It is further preferred that in the closed orientation the side storage portions be held in a closed position by fastening means. It may also be preferred that this be a quick release means such as Velcro®.

It is further preferred that the side storage portions be generally rectangular in shape and be positioned on the sides of the elongate portion such that when a first end of that portion is folded over the side storage portions and fastened to them, a bag device is formed which is accessible through an upper open surface.

It is also preferred that this upper open surface be closed by folding a second end of the elongate portion over this opening and attaching the resulting flap to the second surface of the first end of the elongate portion.

It is also preferred that the fastening means be snap lock closures for convenience although any type of fastening means could be used.

It is further preferred that the handle means be either a handle on an upper surface of the bag or back straps at the rear of the assembled bag to form a back pack arrangement.

It is additionally preferred that detachable accessories for holding baby bottles and the like be attachable to the exterior of the assembled bag and in particular to the sides thereof.

It is further preferred that pocket devices be provided on the second surface of the mat device to provide storage when it is in its closed orientation as a carry bag.

In order that the invention may be more readily understood an embodiment of it will be described by way of non limiting example with reference to the accompanying drawings.

### DESCRIPTION OF THE DRAWING FIGURES

FIG. 1 Shows the mat device in its open orientation;

FIG. 2 Shows the side storage portions folded over one and other;

FIG. 3 Shows a lower part of the elongate portion folded up and clipped to the side storage portions;

FIG. 4 Shows an upper part of the elongate portion folded down to engage with its lower part to form an assembled bag device having a carrying handle;

FIG. 5 Shows a rear view of the assembled bag device with back straps to form a knapsack;

### BRIEF DESCRIPTION OF AN EMBODIMENT OF THE INVENTION

While the bag of the invention could be used for any purpose such as a picnic bag, which also provides a seat surface, it will be described herein in terms of its application as a “baby bag” which can be used to carry items for use with a baby and also provide a change mat.

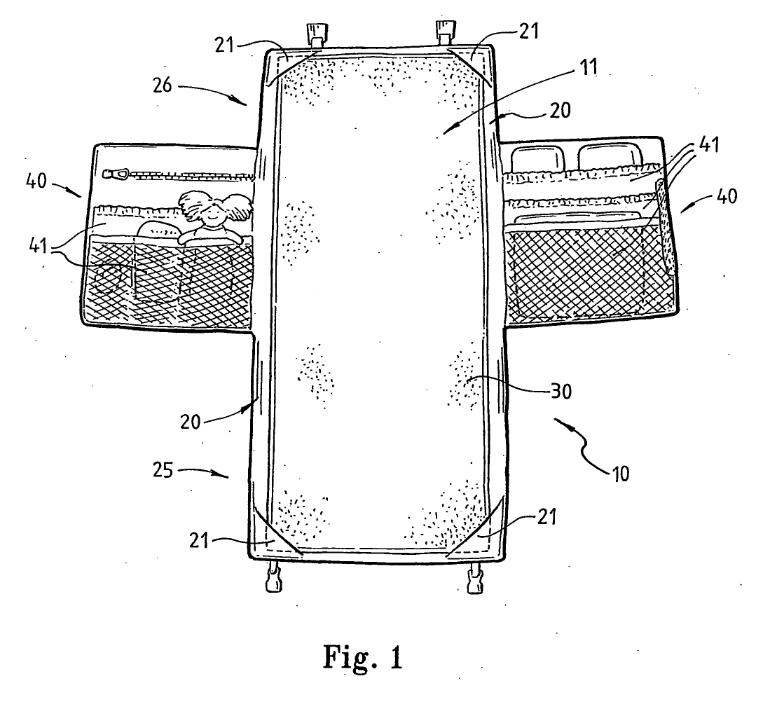

One embodiment of the mat device 10 of the invention is shown in FIG. 1 in an open orientation showing its inner face 11 and having a rear face 12.

The mat device 10 includes an elongate rectangular padded portion 20 which is suitable for laying a baby upon. This portion is provided with a removable vinyl backed liner 30, or towel, which in this embodiment of the mat device may be fastened by whichever means is desired, such as buttons, press studs, Velcro™ or the like, onto the inner or uppermost face 11 of the mat which is formed by the elongate portion of the bag when it is opened out.

It is preferred that the corners of the liner 30 fasten to the corners of the elongate portion 20 under corner flaps 21.

The mat device 10 includes two side portions 40 at either side of the elongate portion 20 and are provided with pockets 41 or other receptacles for holding such baby requirements as spare nappies, wipes, clothing, powder, cleaning devices and whatever else a person wants to carry for the baby.

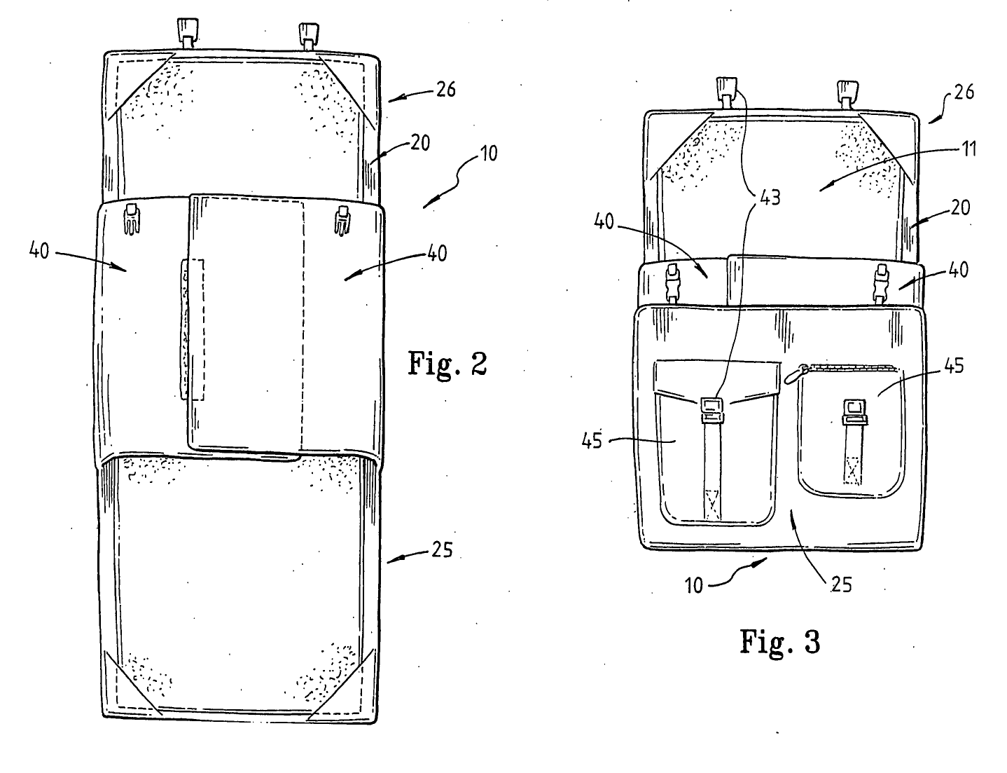

When the mat device 10 is to be folded into its closed position the side storage portions 40 are folded over each other across the elongate portion 20, as shown in FIG. 2, and attached to each other with Velcro® although any other fastening means could be used.

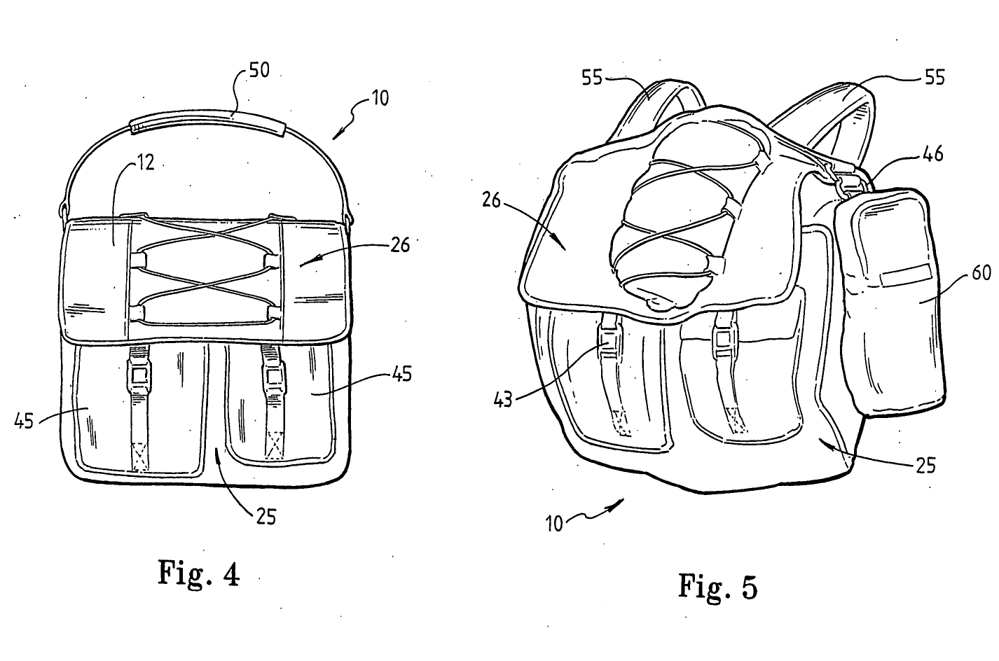

As shown in FIG. 3 the lower part 25 of the elongate portion 20 can then be folded up over the side portions 40 and be attached thereto by snap lock devices 42 although any attachment means could be used. By this means a bag device is formed as shown in FIG. 4 and when the upper part 26 of the elongate portion 20 is folded down and attached to part 25 with snap locks 43 a closed bag is formed having handle means 50.

The arrangement is such that when the effective bag cover 26 is opened access is available to both storage surfaces of the side storage portions 40.

While any arrangement of pockets and the like can be used in association with the bag of the invention in this embodiment of the invention two large pockets 45 are provided on the front of the bag. In addition means 46 are provided on the side of the bag to connect removeable pouches 60 for carrying baby bottles and the like without the need to access the interior of the bag.

A padded handle 50 is provided across the top of the bag as well as back straps 55 to permit it to be carried as a backpack. Any type or combination of carrying means however can form part of the bag of the invention.

In this embodiment of the invention the elongate portion 20, or change station, is made of padded material and the liner 30 is of vinyl backed cotton towelling. It is however envisaged that any appropriate materials desired could be used and still fall within the scope of the invention. Therefore the materials used or the fastening means provided are not limiting in the invention.

The bag of the invention is easy to carry and holds all of a baby's normal requirements. The result is that whatever is needed by a parent is as readily accessible when travelling as it would be when a baby's nappy was changed in the home.

In addition the apparatus takes the form of a compact easy to carry bag which does not require constant packing and unpacking such as is done conventionally.

The padded waterproof mat is particularly desirable as it provides a suitable surface on which to place a baby which is preferable to the common practice of placing a rug, mat or other device on a hard table.

While the internal removable towelling liner is not essential to the general concept of the invention its presence is desirable as it can be easily removed for cleaning and/or washing if necessary. Although in this embodiment of the invention it has been described as Velcroed to the mat it could be affixed by any other appropriate means.

It is further envisaged that other embodiments of the invention will exhibit any number of and any combination of the features of those previously described and whilst we have described herein one specific embodiment of the invention it is to be understood that variations and modifications in this can be made without departing from the spirit and scope thereof.

1-12. (canceled)

13. A mat capable of being in both an open orientation and a closed orientation, comprising:
a surface having a removable fabric mat;
a substantially elongate portion engagable with said removable fabric mat on said surface;
side storage portions having pockets for storing items which, in said open orientation, extend laterally from, and at least partially along, a length of said substantially elongate portion, said mat being foldable and able to be fastened, via fastening means, in said closed orientation into a portable bag; and,
means for carrying said mat.

14. The mat capable of being in both an open orientation and a closed orientation according to claim 13, wherein said means for carrying said mat is a handle attached to an additional surface of said mat.

15. The mat capable of being in both an open orientation and a closed orientation according to claim 13, wherein said substantially elongate portion has a first end that is foldable and engagable with said fastening means on said side storage portions with said first end of said substantially elongate portion forming a front face of a bag having an open upper surface.

16. The mat capable of being in both an open orientation and a closed orientation according to claim 15, wherein said substantially elongate portion has a second end that opposes said first end, said second end being foldable over said front face and capable of being fastened thereto.

17. The mat capable of being in both an open orientation and a closed orientation according to claim 13, further comprising a cover for closing said portable bag.

18. The mat capable of being in both an open orientation and a closed orientation according to claim 13, wherein said fastening means is snap locks.

19. The mat capable of being in both an open orientation and a closed orientation according to claim 13, wherein said means for carrying said mat is a handle attached to an upper surface of said portable bag in said closed orientation of said mat.

20. The mat capable of being in both an open orientation and a closed orientation according to claim 13, wherein said means for carrying said mat include back straps for carrying said mat in said closed orientation.

21. The mat capable of being in both an open orientation and a closed orientation according to claim 13, further comprising storage pockets on a front face of said portable bag in said closed orientation.
